(19) United States
(12) Patent Application Publication
(10) Pub. No.: US 2026/0333484 A1
(43) Pub. Date: Oct. 22, 2026

(54) DEVICE FOR COUPLING NETWORK ELEMENTS AND METHOD FOR COUPLING NETWORK ELEMENTS

(71) Applicant: Robert Bosch GmbH, Stuttgart (DE)

(72) Inventors: Felix Fellhauer, Gerlingen (DE); Alexander Richter, Dresden (DE); Heiko Strohmeier, Renningen (DE); Janik Steyer-Ege, Leonberg (DE)

(21) Appl. No.: 19/561,746

(22) Filed: Mar. 10, 2026

(30) Foreign Application Priority Data
Mar. 12, 2025 (DE) 10 2025 109 386.5

(51) Int. Cl. H04W 76/15

(52) U.S. Cl. CPC H04W 76/15

(57) ABSTRACT

A device for coupling network elements. The device includes a plurality of connections for at least at times connecting the device with at least one further device. The device is configured to exchange data at least at times with the at least one further device via at least one of the plurality of connections. The device further includes: a first transmitting apparatus having a first type, a second transmitting apparatus having a second type that differs from the first type, a first receiving apparatus having the first type, a second receiving apparatus having the second type, wherein the device is configured to selectively a) transmit data via a first connection of the plurality of connections using the first transmitting apparatus or using the second transmitting apparatus, and/or to selectively b) receive data via the first connection using the first receiving apparatus or using the second receiving apparatus.

### FIELD

The present disclosure relates to a device for coupling network elements.

The present disclosure further relates to a method for coupling network elements.

### SUMMARY

Some examples relate to a device for coupling network elements, for example a switch, having a plurality of connections for at least at times connecting the device with at least one other device, wherein the device is configured to at least at times exchange, for example to transmit and/or receive, data with the at least one other device via at least one of the plurality of connections, wherein the device further comprises: at least a first transmitting apparatus having a first type, at least a second transmitting apparatus having a second type that is different from the first type, at least a first receiving apparatus having the first type, at least a second receiving apparatus having the second type, wherein the device is configured to selectively a) transmit data via a first connection of the plurality of connections using the first transmitting apparatus or using the second transmitting apparatus, and/or selectively b) receive data via the first connection using the first receiving apparatus or using the second receiving apparatus. In some examples, this allows for the flexible transmission and/or reception of data, for example via the first connection 110a, for example using different transmitting apparatuses 120a, 120b and/or receiving apparatuses.

For example, the device can be configured as an Ethernet switch, for example according to an IEEE 802.3 standard for Ethernet, for example for, but not limited to, automotive applications.

In some examples, the first type is associated with a first, for example maximum, data transfer rate, wherein, for example, the first, for example maximum, data transfer rate has one of the following elements: a) 100 megabits/s, or b) 1000 megabits/s, or c) 2500 megabits/s, or d) 5000 megabits/s, or e) 10000 megabits/s, wherein, for example, the second type is associated with a second, for example maximum, data transfer rate, wherein, for example, the second, for example maximum, data transfer rate has one of the following elements: a) 100 megabits/s, or b) 1000 megabits/s, or c) 2500 megabits/s, or d) 5000 megabits/s, or e) 10000 megabits/s.

For example, at least one of the transmitting apparatuses is compatible with at least one Ethernet standard, e.g., according to IEEE 802.3, or is based on at least one Ethernet standard, e.g., according to IEEE 802.3.

For example, at least one of the receiving apparatuses is compatible with at least one Ethernet standard, e.g., according to IEEE 802.3, or is based on at least one Ethernet standard, e.g., according to IEEE 802.3.

In some examples, the first type can be configured, for example, according to 100 BASE-T1 (e.g., IEEE 802.3 bw) or a variant using Manchester encoding or differential Manchester encoding as the modulation method, and the second type may be configured, for example, according to 1000 BASE-T1 (e.g., IEEE 802.3 bp), or 2.5/5/10 GBASE-T1 (e.g., IEEE 802.3 ch), or 25 GBASE-T1 (IEEE 802.3 cy). Other types are also possible in further examples.

In some examples, the principle according to the disclosure thus allows, e.g., an asymmetric data exchange with respect to a maximum data rate via at least one of the plurality of connections of the device, which can increase the flexibility, efficiency, and utility of the device.

For example, the device is configured to at least at times transmit data via the first connection using the first transmitting apparatus, and to receive data via the first connection using the second receiving apparatus.

For example, the transmission and reception may overlap at least partially in time, wherein, for example, the transmission and reception take place simultaneously at least at times.

In some examples, the device is configured to at least at times transmit data via the first connection using the second transmitting apparatus, and to receive data via the first connection using the first receiving apparatus, wherein, for example, the transmission and reception overlap at least partially in time, wherein, for example, the transmission and reception take place simultaneously at least at times.

In some examples, the device is configured to at least at times a) transmit data via the first connection using the first transmitting apparatus and receive data via the first connection using the first receiving apparatus, and/or b) transmit data via the first connection using the second transmitting apparatus and receive data via the first connection using the second receiving apparatus.

In some examples, the device comprises a configuration apparatus which is configured for at least one of the following elements: a) connecting the first transmitting apparatus with a specifiable connection, for example the first connection, of the plurality of connections, or b) disconnecting the first transmitting apparatus from a or the specifiable connection, for example the first connection, or c) connecting the second transmitting apparatus with a or the specifiable connection, for example the first connection, of the plurality of connections, or d) disconnecting the second transmitting apparatus from a or the specifiable connection, for example the first connection, wherein, for example, the connection and/or disconnection can be performed dynamically, for example during operation of the device. In this way, different transmitting apparatuses of the device can be used for data exchange via the first connection, as needed. Similar statements also apply in some examples to at least one further connection of the device, for example to all connections of the device.

In some examples, the configuration apparatus is configured for at least one of the following elements: a) connecting the first receiving apparatus with a specifiable connection, for example the first connection, of the plurality of connections, or b) disconnecting the first receiving apparatus from a or the specifiable connection, for example, the first connection, or c) connecting the second receiving apparatus with a or the specifiable connection, for example the first connection of the plurality of connections, or d) disconnecting the second receiving apparatus from a or the specifiable connection, for example the first connection, wherein, for example, the connection and/or disconnection can be performed dynamically, for example, during operation of the device. In this way, different receiving apparatuses of the device can be used for data exchange via the first connection, as needed. Similar statements also apply in some examples to at least one further connection of the device, for example to all connections of the device.

In some examples, the device is configured to at least at times use a frequency division multiplexing method for the transmission and reception, for example simultaneously or at least partially overlapping in time, via at least one of the plurality of connections, for example via a or the first connection. Thus, e.g., simultaneous transmission and reception via the at least one connection is possible, for example without any e.g., significant mutual interference between the two data transfer directions (i.e., transmission or reception). In some examples, e.g., simultaneous transmission and reception, e.g., of the first connection, can take place in different frequency ranges, e.g., with different, for example, maximum, data transfer rates. For example, data can be transmitted according to or based on a 2.5 GBASE-T1 standard in a first frequency range, e.g., corresponding to a baseband, and data can be received, e.g., simultaneously with the transmission, according to or based on a 100 BASE-T1 standard in a second frequency range, e.g., shifted by a carrier frequency which is different from the first frequency range. In some examples, an overlap of the two frequency ranges, for example at least a slight one, can also be tolerated, e.g., less than or equal to 10 percent of the bandwidth of the signals used for transmission and/or reception. In some examples, the overlap can also be greater. In some examples, e.g., one of the two frequency ranges can be e.g., almost completely contained within the other of the two frequency ranges.

In some examples, the device is configured to at least at times use a time division multiplexing method for transmission and reception via at least one of the plurality of connections, for example via a or the first connection.

In further examples, it may be possible to switch e.g., dynamically (during operation) between a frequency division multiplexing method and a time division multiplexing method.

In further examples, a frequency division multiplexing method and a time division multiplexing method can also be combined.

In further examples, the device can be configured to transform at least one transmit signal, which is to be transmitted, for example, using at least the first transmitting apparatus via at least one of the plurality of connections, into a specifiable frequency range, for example a bandpass frequency range, for example using an upconversion using a signal from a local oscillator, wherein, for example, a bandpass transmit signal is obtained, wherein, for example, the device has at least one local oscillator, wherein, for example, the device has at least one mixer apparatus for the upconversion. For example, at least some, for example all, of the signal processing steps mentioned can be implemented using an analog method, or a digital method, or any combination thereof. For example, the bandpass transmit signal obtained in this way can be transmitted via at least one of the plurality of connections of the device. The frequency of the local oscillator can, for example, be chosen based on the bandwidth of the transmit signal.

In some examples, the device is configured to receive a receive signal at least partially overlapping in time with or simultaneously with the transmission, for example via at least one of the plurality of connections, for example via the same connection via which the bandpass transmit signal is transmitted, wherein, for example, the receive signal occupies, for example at least predominantly, a different frequency range than the bandpass transmit signal.

For example, the transmit signal and/or the bandpass transmit signal has a smaller bandwidth than the receive signal, wherein, for example, the transmit signal is associated with a data rate of 100 megabits/s (e.g., according to 100 BASE-T1), and wherein, for example, the receive signal is associated with a data rate greater than 100 megabits/s, for example 1000 megabits/s or more (e.g., according to 2.5 GBASE-T1, 5 GBASE-T1, 10GBASE-T1).

In some examples, the device has at least one filter apparatus, for example for low-pass filtering of the receive signal. In some examples, this allows for efficient separation of the receive signal, e.g., from the bandpass transmit signal.

In further examples, the device is configured monolithically, for example as a system on a chip (SOC), wherein, for example, all components of the device are arranged on a common carrier, for example a substrate.

In some examples, the device has at least one signal processing apparatus configured to process a receive signal received, e.g., via at least one connection of the plurality of connections based on a transmit signal transmitted via the connection, for example at least partially overlapping in time with or simultaneously with the receive signal, for example to at least partially compensate for a possible influence of the transmit signal on the receive signal.

Some examples relate to a method for a device for coupling network elements, for example a switch, wherein the device has a plurality of connections for at least at times connecting the device with at least one other device, wherein the device is configured to at least at times exchange, for example to transmit and/or receive, data with the at least one other device via at least one of the plurality of connections, wherein the device further comprises: at least a first transmitting apparatus having a first type, at least a second transmitting apparatus having a second type that is different from the first type, at least a first receiving apparatus having the first type, at least a second receiving apparatus having the second type, wherein the method comprises: a) selectively transmitting, using the first transmitting apparatus or using the second transmitting apparatus, data via a first connection of the plurality of connections, and/or b) selectively receiving, using the first receiving apparatus or using the second receiving apparatus, data via the first connection.

Further examples relate to a device for data exchange with a device for coupling network elements according to the disclosure, wherein the device has at least one connection for at least at times connecting the device with the device for coupling network elements, wherein the device has a transmitting apparatus having a third type and a receiving apparatus having a fourth type, wherein the fourth type is different from the third type. In some examples, the third type can e.g., correspond to the first type, and the fourth type can e.g., correspond to the second type. This allows for asymmetric data transfer, e.g., with regard to a maximum data transfer rate.

Further examples relate to a system comprising at least one device for coupling network elements according to the disclosure (e.g., according to claim 1) and at least one device according to the disclosure (e.g., according to claim 18).

Further examples relate to the use of the device for coupling network elements according to the disclosure and/or of the method according to the disclosure and/or of the device according to the disclosure and/or of the system according to the disclosure for at least one of the following elements: a) data exchange with at least one further device, or b) exchanging data with different, for example maximum, data rates for transmitting and receiving the data, or c) flexibly configuring at least one connection of the device for exchanging data with similar or different, for example maximum, data rates for transmitting and receiving the data, or d) increasing the flexibility for a data transfer, or e) implementing data transfers with different, for example maximum, data rates based on, for example conventional, implementations of interface apparatuses.

Further features, possible applications and advantages can be found in the following description of examples, which are shown in the figures. All features described or shown form the subject matter of the present disclosure individually or in any combination, regardless of their wording or representation in the description or in the figures.

### BRIEF DESCRIPTION OF THE DRAWINGS

FIG. 1 schematically shows a block diagram, according to an example embodiment.

FIG. 2 schematically shows a flow chart, according to an example embodiment.

FIG. 3 schematically shows a flow chart, according to an example embodiment.

FIG. 4 schematically shows a flow chart, according to an example embodiment.

FIG. 5 schematically shows a flow chart, according to an example embodiment.

FIG. 6 schematically shows a flow chart, according to an example embodiment.

FIG. 7 schematically shows a flow chart, according to an example embodiment.

FIG. 8 schematically shows a flow chart, according to an example embodiment.

FIG. 9 schematically shows a flow chart, according to an example embodiment.

FIG. 10 schematically shows a flow chart, according to an example embodiment.

FIG. 11 schematically shows a block diagram, according to an example embodiment.

FIG. 12 schematically shows spectra, according to an example embodiment.

FIG. 13 schematically shows aspects of a time division multiplexing method, according to an example embodiment.

FIG. 14 schematically shows a block diagram, according to an example embodiment.

FIG. 15 schematically shows a block diagram, according to an example embodiment.

FIG. 16 schematically shows a block diagram, according to an example embodiment.

FIG. 17 schematically shows aspects of uses, according to an example embodiment.

### DETAILED DESCRIPTION OF EXAMPLE EMBODIMENTS

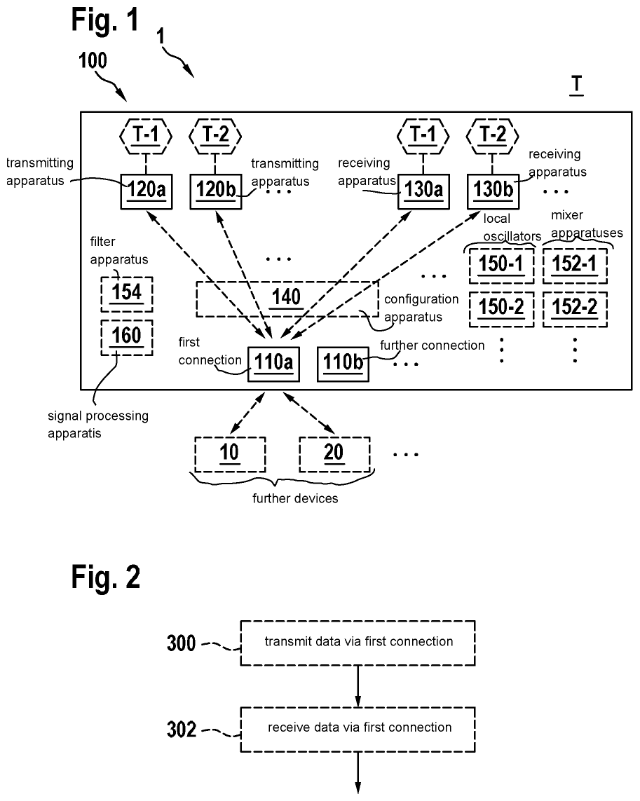

Some examples, see e.g., FIGS. 1, 2, relate to a device 100 for coupling network elements, for example a switch, having a plurality of connections 110a, 110b, . . . for at least at times connecting the device 100 with at least one further device 10, 20, . . . , wherein the device 100 is configured to at least at times exchange, for example to transmit and/or receive, data with the at least one further device 10, 20, . . . via at least one of the plurality of connections 110a, 110b, . . . , wherein the device 100 further comprises: at least a first transmitting apparatus 120a having a first type T-1, at least a second transmitting apparatus 120b having a second type T-2 that is different from the first type T-1, at least a first receiving apparatus 130a having, e.g., the first type T-1, at least a second receiving apparatus 130b having, e.g., the second type T-2, wherein the device 100 is configured to selectively a) transmit 300 data via a first connection 110a of the plurality of connections (FIG. 2) using the first transmitting apparatus 120a or using the second transmitting apparatus 120b, and/or to selectively b) receive 302 data via the first connection 110a using the first receiving apparatus 130a or using the second receiving apparatus 130b. In some examples, this allows for flexible transmission 300 and/or reception 302 of data, for example via the first connection 110a, for example using different transmitting apparatuses 120a, 120b and/or receiving apparatuses 130a, 130b.

For example (FIG. 1), the device 100 can be configured as an Ethernet switch, e.g., according to an Ethernet standard according to IEEE 802.3, for example for, but not limited to, automotive applications.

In some examples (FIG. 1), the first type T-1 is associated with a first, for example maximum, data transfer rate, wherein, for example, the first, for example maximum, data transfer rate has one of the following elements: a) 100 megabits/s, or b) 1000 megabits/s, or c) 2500 megabits/s, or d) 5000 megabits/s, or e) 10000 megabits/s, wherein, for example, the second type T-2 is associated with a second, for example maximum, data transfer rate, wherein, for example, the second, for example maximum, data transfer rate has one of the following elements: a) 100 megabits/s, or b) 1000 megabits/s, or c) 2500 megabits/s, or d) 5000 megabits/s, or e) 10000 megabits/s. In further examples, data rates other than those mentioned above as examples are also possible.

For example (FIG. 1), at least one of the transmitting apparatuses 120a, 120b, . . . is compatible with at least one Ethernet standard, e.g., according to IEEE 802.3, or is based on at least one Ethernet standard.

For example (FIG. 1), at least one of the receiving apparatuses 130a, 130b, . . . is compatible with at least one Ethernet standard, e.g., according to IEEE 802.3, or is based on at least one Ethernet standard.

In some examples, the first type T-1 can be configured, for example, according to 100 BASE-T1, and the second type T-2 can be configured, for example, according to 2.5 GBASE-T1. Other combinations or types are also possible in further examples.

In some examples, the principle according to the disclosure thus allows, e.g., an asymmetric data exchange with respect to a maximum data transfer rate via at least one connection 110a of the plurality of connections of the device 100, which can increase the flexibility and utility of the device 100.

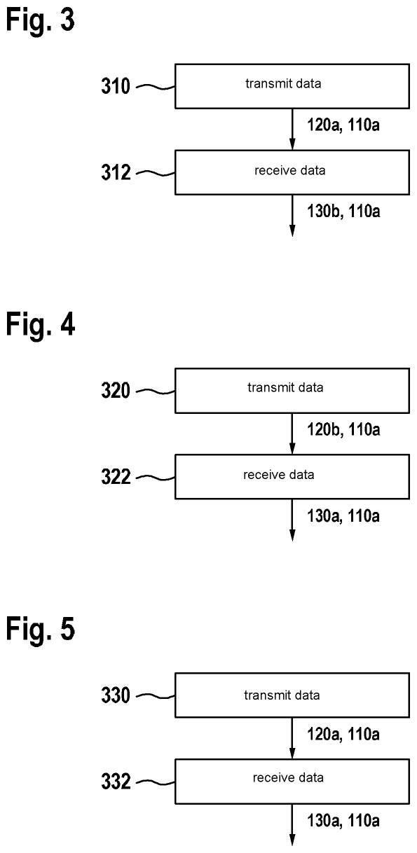

For example (FIG. 3), the device 100 is configured to at least at times transmit 310 data via the first connection 110a using the first transmitting apparatus 120a, and to receive 312 data via the first connection 110a using the second receiving apparatus 130b. This allows the transmission 310 of data using a first type T-1 of transmitting apparatus 120a and the reception 312 of data using a second type T-2 of receiving apparatus 130b. For example (FIG. 3), the transmission 310 and the reception 312 may overlap at least partially in time, wherein, for example, the transmission 310 and the reception 312 take place simultaneously at least at times.

In some examples (FIG. 4), the device 100 is configured to at least at times transmit 320 data via the first connection 110a using the second transmitting apparatus 120b, and to receive 322 data via the first connection 110a using the first receiving apparatus 130a, wherein, for example, the transmission 320 and the reception 322 overlap at least partially in time, wherein, for example, the transmission 320 and the reception 322 take place simultaneously at least at times.

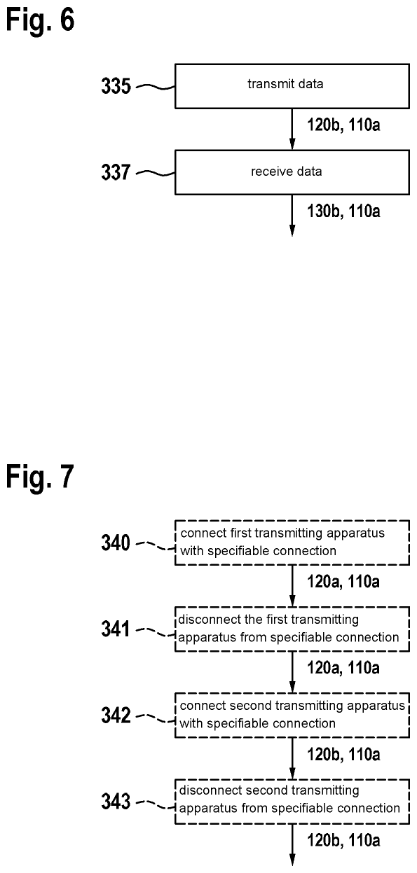

In some examples (FIGS. 5, 6), the device 100 is configured to at least at times a) transmit 330 data via the first connection 110a using the first transmitting apparatus 120a, and to receive 332 data via the first connection 110a using the first receiving apparatus 130a, and/or b) to transmit 335 data via the first connection 110a using the second transmitting apparatus 120b, and receive 337 data via the first connection 110a using the second receiving apparatus 130b, which in some examples can allow at least at times a data exchange that is symmetrical with respect to the data transfer rate.

In some examples (FIGS. 1, 7), the device 100 comprises a configuration apparatus 140 which is configured for at least one of the following elements: a) connecting 340 the first transmitting apparatus 120a with a specifiable connection, for example the first connection, 110a of the plurality of connections, or b) disconnecting 341 the first transmitting apparatus 120a from a or the specifiable connection, for example the first connection, 110a, or c) connecting 342 the second transmitting apparatus 120b with a or the specifiable connection, for example the first connection, 110a, of the plurality of connections, or d) disconnecting 343 the second transmitting apparatus 120b from a or the specifiable connection, for example the first connection, 110a, wherein, for example, the connection 340, 342 and/or the disconnection 341, 343 can be performed dynamically, for example during operation of the device 100. In this way, different transmitting apparatuses 120a, 120b of the device can be used for data exchange via the first connection 110a, as needed.

Similar statements also apply in some examples to at least one further connection 110b, . . . of the device 100, for example to all connections 110a, 110b, . . . of the device 100. Thus, in some examples, a plurality of, for example all, connections 110a, 110b, . . . of the device can be selectively and/or dynamically connected to transmitting apparatuses and/or receiving apparatuses of the same type or of a different type, thereby providing increased flexibility and efficiency, compared to some conventional approaches, with regard to the transmitting and receiving apparatuses to be implemented.

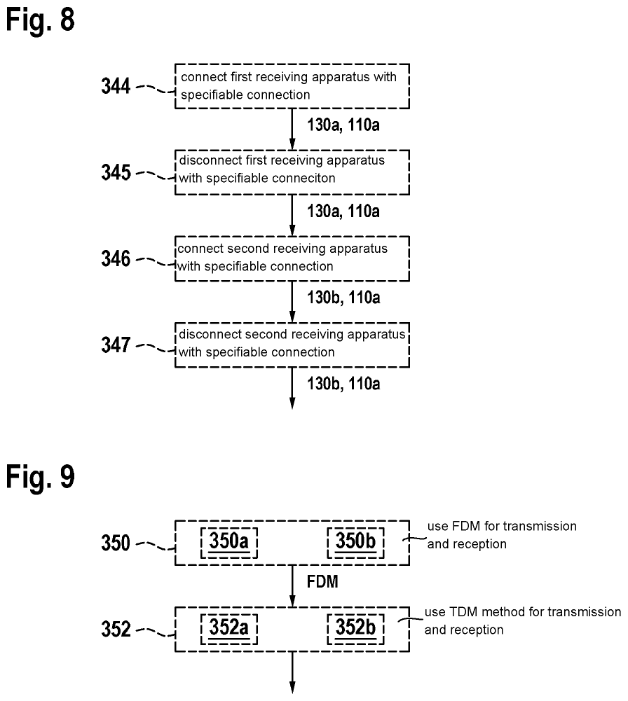

In some examples (FIGS. 1, 8), the configuration apparatus 140 is configured for at least one of the following elements: a) connecting 344 the first receiving apparatus 130a with a specifiable connection, for example the first connection, 110a of the plurality of connections, or b) disconnecting 345 the first receiving apparatus 130a from a or the specifiable connection, for example the first connection, 110a, or c) connecting 346 the second receiving apparatus 130b with a or the specifiable connection, for example the first connection, 110a, of the plurality of connections, or d) disconnecting 347 the second receiving apparatus 130b from a or the specifiable connection, for example the first connection, 110a, wherein, for example, the connection 344, 346 and/or the disconnection 345, 347 can be performed dynamically, for example during operation of the device 100. In this way, different receiving apparatuses 130a, 130b of the device 100 can be used for data exchange via the first connection 110a, as needed. Similar statements also apply in some examples to at least one further connection 110b, . . . of the device 100, for example to all connections of the device 100.

In some examples (FIGS. 1, 9), the device 100 is configured to at least at times use 350 a frequency division multiplexing method FDM for the transmission 350a and reception 350b, for example simultaneously or at least overlapping in time, via at least one of the plurality of connections, for example via a or the first connection 110a. Thus, e.g., simultaneous transmission 350a and reception 350b via the at least one connection 110a is possible, for example without any, e.g., significant, mutual interference between the two data transfer directions (i.e., transmission or reception).

In some examples (FIG. 9), e.g., simultaneous transmission 350a and reception 350b with respect to, e.g., the first connection 110a can take place in different frequency ranges, e.g., in each case with different, for example maximum, data transfer rates. For example, data can be transmitted according to or based on a 2.5 GBASE-T1 standard in a first frequency range, e.g., corresponding to a baseband (see block 350a), and data can be received, for example simultaneously with the transmission 350a, according to or based on a 100 BASE-T1 standard in a second frequency range that is different from the first frequency range (see block 350b). In some examples, an overlap, for example a slight overlap, of the two frequency ranges can also be tolerated, e.g., less than or equal to 10 percent of the bandwidth of the signals used for transmission 350a and/or reception 350b. In further examples, other types of standards besides those mentioned above as examples can be used for transmission and/or reception according to the frequency division multiplexing (FDM) method.

In some examples (FIGS. 1, 9), the device 100 is configured to at least at times use 352 a time division multiplexing (TDM) method for transmission 352a and reception 352b via at least one of the plurality of connections, for example via a or the first connection 110a.

In further examples, it is possible to switch dynamically (during operation of the device 100) between a frequency division multiplexing method (FDM) and a time division multiplexing method (TDM).

In further examples, a frequency division multiplexing (FDM) method and a time division multiplexing (TDM) method can also be combined.

In some examples, the principle according to the disclosure can also be used to at least at times implement full-duplex data transfers, in which the signals to be exchanged (e.g., for transmission and reception) overlap at least at times both in the time range and in the frequency range. Even for such full-duplex data transfers, different transmitting and/or receiving apparatuses, e.g., including of different types, can be used in some examples.

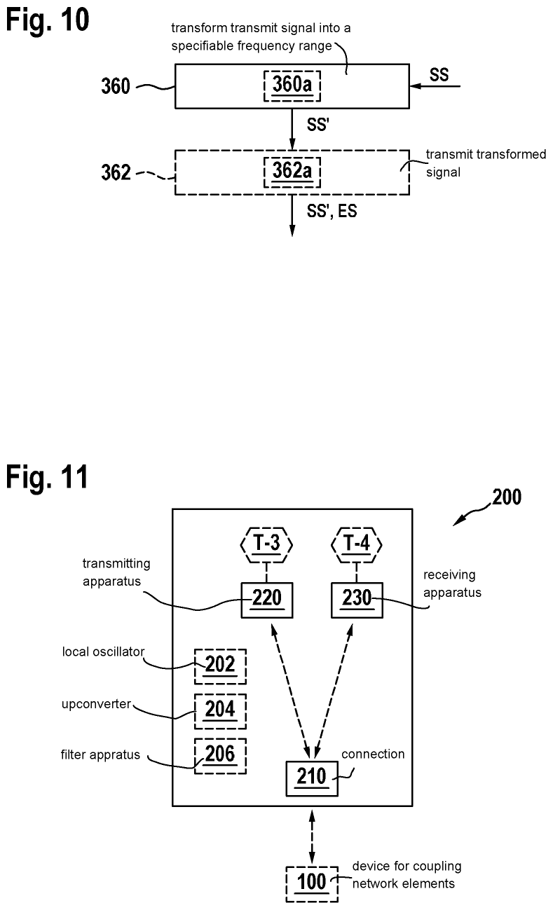

In further examples (FIGS. 1, 10), the device 100 can be configured to transform at least one transmit signal SS, which is to be transmitted, for example, using at least the first transmitting apparatus 120a via at least one of the plurality of connections, into a specifiable frequency range, for example a bandpass frequency range, 360, for example using an upconversion 360a using a signal from a local oscillator, wherein, for example, a bandpass transmit signal SS′ is obtained, wherein, for example, the device 100 (FIG. 1) has at least one local oscillator 150-1, 150-2, . . . , wherein, for example, the device 100 has at least one mixer apparatus 152-1, 152-2, . . . for the upconversion 360a. For example, the bandpass transmit signal SS′ obtained in this way can be transmitted via at least one of the plurality of connections 110a, 110b, . . . of the device 100; see the optional block 362 according to FIG. 10. The frequency of the local oscillator 150-1 can, for example, be chosen based on a bandwidth of the transmit signal ss.

In some examples (FIG. 10), the device 100 is configured to receive a receive signal ES at least partially overlapping in time with or simultaneously with the transmission 360 (see block 362a), for example via at least one of the plurality of connections, for example via the same connection 110a via which the bandpass transmit signal SS′ is transmitted, wherein, for example, the receive signal ES occupies, for example at least predominantly, a different frequency range than the bandpass transmit signal SS′.

For example, the transmit signal SS and/or the bandpass transmit signal SS′ has a smaller bandwidth than the receive signal ES, wherein, for example, the transmit signal SS is associated with a data rate of 100 megabits/s (e.g., according to 100 BASE-T1), wherein, for example, the receive signal ES is associated with a data rate greater than 100 megabits/s, for example 1000 megabits/s or more (e.g., according to 2.5GBASE-T1).

In some examples (FIG. 1), the device 100 has at least one filter apparatus 154, for example for low-pass filtering of the receive signal ES. In some examples, this allows for efficient separation of the receive signal ES in a frequency range, e.g., from the passband transmit signal SS′.

In further examples (FIG. 1), the device 100 is configured monolithically, for example as a system on a chip (SoC), wherein, for example, a plurality of, for example all, components of the device 100 are arranged on a common carrier T, for example a substrate.

In some examples (FIG. 1), the device 100 has at least one signal processing apparatus 160 configured to process a receive signal ES received, e.g., via at least one connection 110a of the plurality of connections based on a transmit signal SS, SS′ transmitted via the connection 110a, for example at least partially overlapping in time with or simultaneously with the receive signal ES, for example to at least partially compensate for a possible influence of the transmit signal SS, SS′ on the receive signal ES. In some examples, this allows e.g., full-duplex operation, which is substantially free of influence by the transmit signal SS, SS′.

Some examples (FIG. 2) relate to a method for a device 100 for coupling network elements, for example a switch, wherein the device 100 has a plurality of connections for at least at times connecting the device with at least one other device, wherein the device is configured to at least at times exchange, for example to transmit and/or receive, data with the at least one other device via at least one of the plurality of connections, wherein the device further comprises: at least a first transmitting apparatus having a first type, at least a second transmitting apparatus having a second type that is different from the first type, at least a first receiving apparatus having the first type, at least a second receiving apparatus having the second type, wherein the method comprises: a) selectively transmitting 300, using the first transmitting apparatus 120a or using the second transmitting apparatus 120b, data via a first connection 110a of the plurality of connections, and/or b) selectively receiving 302, using the first receiving apparatus 130a or using the second receiving apparatus 130b, data via the first connection 110a.

Further examples (FIG. 11) relate to a device 200 for data exchange with a device 100 (FIG. 1) for coupling network elements according to the disclosure, wherein the device 200 (FIG. 11) has at least one connection 210 for at least at times connecting the device 200 with the device 100 for coupling network elements, wherein the device 200 has a transmitting apparatus 220 having a third type T-3 and a receiving apparatus 230 having a fourth type T-4, wherein the fourth type T-4 is different from the third type T-3. In some examples, the third type T-3 can correspond e.g., to the first type T-1 (FIG. 1), and the fourth type T-4 can correspond e.g., to the second type T-2. This allows, e.g., an asymmetric data transfer with the device 100 with regard to a maximum data transfer rate. For example, at least one of the elements 10, 20 according to FIG. 1 can have a configuration 200 according to FIG. 11.

In some examples (FIG. 11), the device 200 can have a local oscillator 202 and an upconverter 204, e.g., for upconversion of a signal to be transmitted using the device 200 or its transmitting apparatus 220.

In some examples, the device 200 can have a filter apparatus 206, e.g., comprising or representing a low-pass filter, e.g., for separating signals present in different frequency ranges for reception/transmission by the device 200.

Further examples (FIG. 1), relate to a system 1 comprising at least one device 100 for coupling network elements according to the disclosure (e.g., according to claim 1) and at least one device 200 according to the disclosure (e.g., according to claim 18; see also FIG. 11).

The system 1 according to the present disclosure can in some examples e.g., be used in vehicles, such as motor vehicles, but is not limited to such applications.

FIG. 12 schematically shows spectra of signals according to some examples. The element S1 symbolizes a spectrum of a transmit signal in a first frequency range, e.g., in a bandpass position around a center or support frequency f1>0, and the element S2 symbolizes a spectrum of a receive signal in a second, for example lower, frequency range, for example (but not necessarily) a baseband position. In some further examples (not shown), the spectra S1 and S2 can also overlap at least partially. E. g., one spectrum can be completely contained within another spectrum.

In some examples (FIG. 12), a signal associated with the spectrum S1 can be received, e.g., by a receiving apparatus 130a (FIG. 1) of type 100 BASE-T1, or for example 10 BASE-T1S, or for example a differential Manchester encoded (DME) signal, for example with a useful data rate of 100 Mbps or less, e.g., after an optional frequency conversion (e.g., down-conversion) into a baseband position, e.g., using a mixer apparatus 152-1, e.g., based on a signal from a local oscillator 154-1, which e.g., also has the frequency f1.

In some examples, the device according to the disclosure is thus configured for at least one of the following elements: a) generating a differential Manchester encoded signal, or b) providing a differential Manchester encoded signal, or c) transmitting a differential Manchester encoded signal, or d) receiving a differential Manchester encoded signal, or e) upconverting a differential Manchester encoded signal, or f) downconverting a differential Manchester encoded signal, or g) processing, for example in some other way, a differential Manchester encoded signal, or h) filtering a differential Manchester encoded signal, or i) combining a differential Manchester encoded signal, for example in a time range and/or a frequency range, with at least one other signal, for example a differential Manchester encoded signal or a signal of a different type.

In some examples, the differential Manchester encoded signal has a data rate, for example useful data rate, of 100 megabits per second (Mbps) or less.

In some examples (FIG. 12), a transmit signal associated with the spectrum S2 can be provided, e.g., by a transmitting apparatus 120b (FIG. 1) of type 2.5 GBASE-T1, 5G BASE-T1, or 10 GBASE-T1 (e.g., according to IEEE 802.3ch). As already described, the spectrum S2 represents a transmit signal in baseband position, wherein it should be noted that the schematic representation according to FIG. 12 does not show any spectral components of the spectrum S2, which may be present, for negative frequencies f for the sake of clarity.

The spectral configuration shown as an example in FIG. 12 can thus result, in some examples, e.g., in that the device 100 (FIG. 1) generates a transmit signal of type 2.5GBASE-T1 with the spectrum S2 using a transmitting apparatus 120b and outputs it, e.g., via the first connection 110a, and in that the device 100 receives a receive signal of type 100 BASE-T1 with the spectrum S1 via the first connection 110a, e.g., simultaneously with the transmission of the transmit signal. In some examples, a corresponding configuration of the device 100 or at least some components 120b, 130a, . . . of the device 100 can be specified or executed using the configuration apparatus 140. The principle described above with reference to FIG. 12 is also applicable, in some examples, to further connections 110b, . . . of the device 100.

FIG. 13 shows examples of aspects of a time multiplexing method according to some examples. The elements Rx1a, Rx1b show activity of the receiving apparatus 130a at time intervals T1a, T1b, e.g., for receiving signals of type 2.5 GBASE-T1 via the connection 110a, while the elements Tx2a, Tx2b, Tx2c symbolize activity of the transmitting apparatus 120b at time intervals T2a, T2b, T2c for transmitting signals of type 100 BASE-T1 via the same connection 110a. The principle described above with reference to FIG. 13 is also applicable, in some examples, to further connections 110b, . . . of the device 100.

As described above, in further examples, combinations of time division multiplexing and frequency division multiplexing can also be used, at least at times, for data exchange via at least one connection 110a, . . . of the device 100.

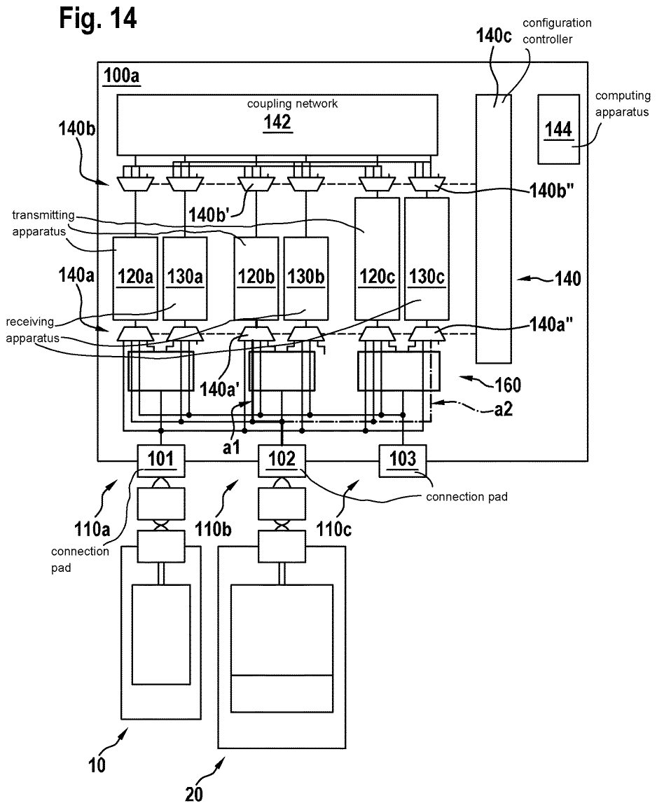

FIG. 14 schematically shows a device 100a according to the disclosure, configured by way of example as an Ethernet switch. For example, the switch 100a can be configured to connect a plurality of other devices 10 (e.g., a control unit for a vehicle), 20 (e.g., a camera apparatus for the vehicle) to each other and/or with at least one other device (not shown).

The device 100a has a plurality of connections 110a, 110b, 110c, a plurality of transmitting apparatuses 120a, 120b, 120c, and a plurality of receiving apparatuses 130a, 130b, 130c.

Furthermore, a configuration apparatus 140 is provided, which in some examples comprises first multiplexer apparatuses, collectively designated by reference sign 140a in FIG. 14, as well as second multiplexer apparatuses, collectively designated by reference sign 140b in FIG. 14, and a configuration controller 140c, e.g., for at least some of the multiplexer apparatuses 140a, 140b; see also the dashed lines extending from element 140c to the elements 140a, 140b in FIG. 14. Element 142 symbolizes a core of the switch 100a, for example comprising or representing a coupling network, and the optional block 144 symbolizes an optional computing apparatus, for example comprising a processor apparatus, for example a central processing unit, e.g., CPU, which can e.g., control the operation of components of the device 100a. In some examples, the functionality of the optional CPU 142 can e.g., also be integrated into component 140c.

The reference sign 160 according to FIG. 14 collectively symbolizes aspects of the signal processing apparatus according to some examples, which is configured to process a receive signal, received e.g., via at least one connection 110a of the plurality of connections based on a transmit signal transmitted via the connection 110a, for example at least partially overlapping in time with or simultaneously with the receive signal ES, for example to at least partially compensate for a possible influence of the transmit signal on the receive signal. This allows e.g., full-duplex operation in some examples. If, e.g., full-duplex data communication is not to be carried out, the signal processing apparatus 160 can e.g., also be omitted.

In some examples (FIG. 14), the transmitting apparatuses 120a, 120b and the receiving apparatuses 130a, 130b have a first type, e.g., 100 BASE-T1. In some examples, the transmitting apparatus 120c and the receiving apparatus 130c have a second type, e.g., 2.5 GBASE-T1.

In some examples (FIG. 14), the different transmitting apparatuses 120a, 120b, 120c can be selectively connected to a corresponding connection 110a, 110b, 110c of the device 100a, for example by a part of the first multiplexer apparatuses 140a, for example under the control of the configuration controller 140c. Similarly, the different transmitting apparatuses 120a, 120b, 120c can be selectively connected to corresponding connections of the coupling network 142, for example by a part of the second multiplexer apparatuses 140b, for example under the control of the configuration controller 140c. In this way, in some examples, e.g., a data path originating from the coupling network 142 can be established via a specifiable transmitting apparatus 120a to a specifiable connection 110a, in order to allow the data to be transmitted via the connection 110a using the specifiable transmitting apparatus 120a.

In some examples (FIG. 14), the different receiving apparatuses 130a, 130b, 130c can be selectively connected to a corresponding connection 110a, 110b, 110c of the device 100a, for example by a part of the first multiplexer apparatuses 140a, for example under the control of the configuration controller 140c. Similarly, the different receiving apparatuses 130a, 130b, 130c can be selectively connected to corresponding connections of the coupling network 142, for example by a part of the second multiplexer apparatuses 140b, for example under the control of the configuration controller 140c. In this way, in some examples, a data path originating from the coupling network 142 can be established via a specifiable receiving apparatus 130a to a specifiable connection 110a in order to allow data to be received via the connection 110a using the specifiable receiving apparatus 120a.

In some examples (FIG. 14), it is thus possible, e.g., to connect the second transmitting apparatus 120b of type 100 BASE-T1 and the third receiving apparatus 130 c of type 2.5 GBASE-T1 at least at times to the second connection 110b of the device 100a and to connect the two apparatuses 120b, 130c in a corresponding manner to the coupling network 142 in order to allow a data exchange that is asymmetric with respect to the maximum data transfer rate, e.g., with the further device 20, e.g., receiving data from the further device 20 at up to 2.5 gigabits/s and transmitting data to the further device 20 at up to 100 megabits/s. In some examples, the additional transmitting apparatuses 120a, 120c and/or the additional receiving apparatuses 130a, 130b can be connected with at least one other connection 110a, 110c.

For example (FIG. 14), the control unit 10 can be connected to the connection 110a of the device 100a via a symmetrical data connection, e.g., according to 100 BASE-T1. For this purpose, the device 100a can at least at times connect the first transmitting apparatus 120a and the first receiving apparatus 130a to the first connection 110a and establish a corresponding connection of the components 120a, 130a to the coupling network 142. This allows, e.g., the control unit 10 to exchange data with the camera apparatus 20 via the switch 100a at a maximum data rate of 100 megabits/s. In contrast, the camera apparatus 20 can transmit data to the switch 100a at a maximum data rate of 2.5 gigabits/s, e.g., to forward the data to a data sink (not shown), which can also be connected e.g., via 2.5 GBASE-T1 to the switch 100a, e.g., via the third connection 110c.

For example, if the camera apparatus 20 transmits data to the switch 100a at a lower data rate, the receiver apparatus 130c can be disconnected from the connection 110b and the receiver apparatus 130b can be connected to the connection 110b, e.g., dynamically. In this way, the maximum possible data rate for the connection 110b can be flexibly adjusted, e.g., to adapt to different operating scenarios. Similar statements also apply to the other connections 110a and 110c of the switch 100a in further examples.

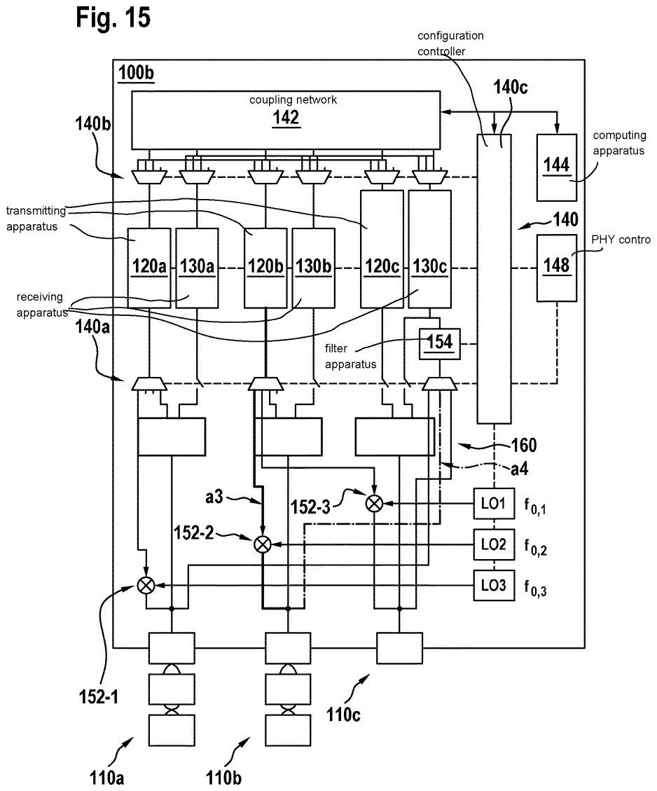

FIG. 15 shows a configuration of a device 100b similar to the configuration 100a according to FIG. 14, according to some examples. In addition to the configuration 100a according to FIG. 14, the configuration 100b according to FIG. 15 has a plurality of local oscillators LO1, LO2, LO3 with different frequencies and, in each case, associated mixer apparatuses 152-1, 152-2, 152-3, for example for an upconversion in each case of transmit signals from at least some transmitting apparatuses 120a, 120b.

In some examples, at least some of the mixer apparatuses 152-1, 152-2, 152-3 and, e.g., at least one of the local oscillators LO1, LO2, LO3 can alternatively or additionally also be used, at least at times, for downmixing, which allows, for example, a signal received in bandpass position to be transformed to a baseband range.

Furthermore, the configuration 100b according to FIG. 15 includes a filter apparatus 154, for example for optional low-pass filtering of a signal received from at least one of the connections 110a, 110b, 110c, e.g., for separating the spectrum S2 according to FIG. 12 from the spectrum S1. Likewise, the configuration 100b according to FIG. 15 can include an optional additional control, e.g., “PHY control,” 148, which can e.g., at least at times control at least one aspect of the signal processing apparatus 160, for example for full duplex operation of at least one connection 110a, 110b, 110c.

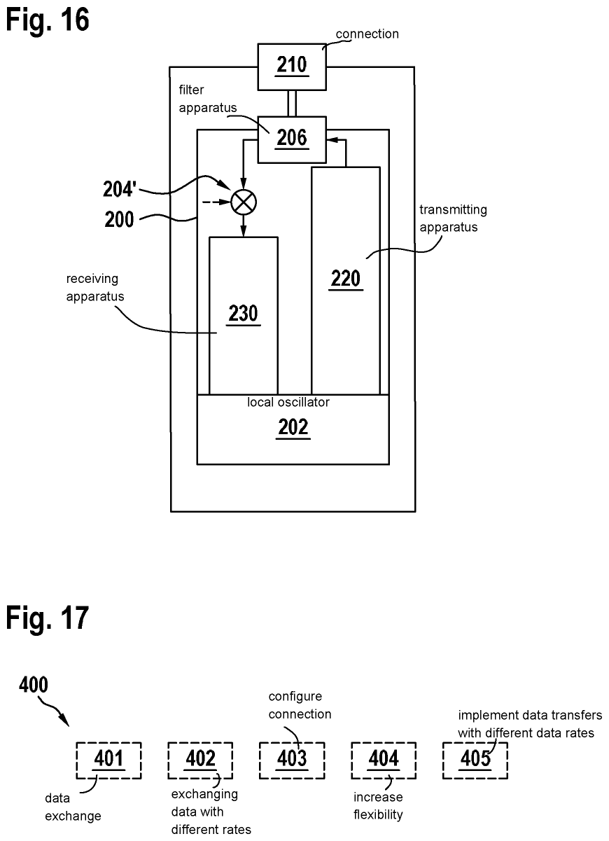

FIG. 16 schematically shows aspects of a device 200, for example similar to FIG. 11, for example configured as a camera apparatus, for data exchange, for example via the device, for example via the switch, 100, 100a, 100b, according to the disclosure. The device 200 includes a data source such as an image sensor 202, a transmitting apparatus 220 and a receiving apparatus 230. In some examples (FIG. 16), the device 200 has a local oscillator (not shown in FIG. 16) and a downmixer 204′, e.g., for downmixing a signal received by the device 200; see e.g., the spectrum S1 according to FIG. 12.

In some examples (FIG. 16), the device 200 can have a filter apparatus 206, e.g., comprising or representing a low-pass or band-pass filter, e.g., for separating signals present in different frequency ranges for reception/transmission by the device 200. For example, the receiving apparatus 230, e.g., of type 100 BASE-T1, implements a receive path with a maximum data transfer rate of 100 megabits/s, and the transmitting apparatus 220, e.g., of type 2.5 GBASE-T1, implements a transmit path with a maximum data transfer rate of 2.5 gigabits/s. The design of the receive path and transmit path in the device 200, asymmetrical with respect to the data transfer rate, according to some examples, allows e.g., the efficient transmission of comparatively large amounts of data to the switch 100, 100a, 100b or to a connected data sink, while the comparatively low data transfer rate is sufficient in many cases for receiving control information, e.g., for operating the camera apparatus 200.

Further aspects and examples are described below, which, in further examples, can each be combined, individually or in any combination with one another, with at least one of the aspects and/or examples described above.

The principle according to the disclosure allows an efficient implementation of a device 100, 100a, 100b for coupling network elements, which can be used for example in a vehicle computer for a vehicle or in a zone control unit for a vehicle. For example, according to the disclosure, the device allows flexible connection of further devices with selectively different maximum data transfer rates, e.g., according to different Ethernet standards, wherein comparatively old or “slow” speed levels such as e.g., 10 megabits/s are also possible. Furthermore, the device according to the disclosure allows a flexible provision of the different speed levels at freely specifiable connections 110a, 110b, . . . of the device, which can be achieved for example using the configuration apparatus 140, can selectively connect the transmitting apparatuses and/or receiving apparatuses of different types T-1, T-2 to corresponding connections 110a, 110b, . . . of the device or to the corresponding connections of the coupling network 142. In this way, novel, e.g., asymmetric speed levels (such as transmission at 100 megabits/s and reception at 2.5 gigabits/s) can also be implemented flexibly, while, e.g., the complexity of the device 100, 100a, 100b, for example in the form of the SoC, is kept at a comparatively manageable level.

In some cases, the principle according to the disclosure can be applied to frequency and/or time division multiplexing, e.g., of existing physical layers, e.g., according to an Ethernet standard, e.g., the IEEE Automotive Ethernet standard.

In some examples, the principle according to the disclosure can be used for efficient multiplexing of interface components, e.g., PHYs; see also the transmitting apparatuses 120a, 120b, . . . and/or the receiving apparatuses 130a, 130b, . . . , which in some examples can implement at least some aspects of an Ethernet PHY, and which, according to the principle of the disclosure, can e.g., be flexibly assigned to different connections 110a, 110b, . . . of the device.

In some examples, the principle according to the disclosure makes it possible to dissolve or split existing, e.g., conventional, e.g., monolithic, PHY implementations into multiple parts, for example two or more parts, wherein a first part is a transmission part, e.g., implementable by the at least one transmitting apparatus 120a, wherein a second part is a receiving part, for example implementable by the at least one receiving apparatus 130a.

An optional third, for example common, part, which relates e.g., to aspects of both transmission and reception, can in some examples be implemented e.g., using the signal processing apparatus 160, which processes receive signals received at a specific connection 110a based on transmit signals transmitted via the specific connection 110a (e.g., simultaneously), for example to reduce, e.g., to compensate for, any potentially interfering influence of the transmit signals on the receive signals.

In some examples, the configuration apparatus 140 makes it possible to dynamically configure these different parts, e.g., at the silicon or circuit level, for example to combine them with each other, e.g., to connect them, and/or to separate them from each other, e.g., to selectively combine different transmitting and/or receiving apparatuses or types of transmitting and/or receiving apparatuses with at least one connection, e.g., to connect them. Similarly, the configuration apparatus 140 can also dynamically combine further components of the device 100, 100a, 100b with the aforementioned elements, e.g., connect or separate them, such as at least one of: a) mixing apparatuses, or b) local oscillator, or c) filter apparatus, etc.

In some examples, the principle according to the disclosure allows for the implementation of asymmetric data rates (i.e., different maximum data transfer rates for transmission and reception, e.g., over the same connection) on the basis of existing, e.g., standardized (or e.g., currently almost standardized) PHY implementations. In further examples, future PHY implementations can also be integrated into the device according to the disclosure relatively easily.

In some examples, the principle according to the disclosure allows for increased flexibility in the design of the device, for example a design for a SOC or a circuit layout for the device, and thus also allows e.g. simpler integration, even under difficult conditions in a target system (e.g., a housing with many constraints).

In some examples, the principle according to the disclosure allows an increase in efficiency with respect to a required silicon surface area (e.g., associated with a chip size), e.g., in an implementation as a SoC, since a circuit implemented in silicon, e.g., can be used to implement multiple connections at multiple locations and/or in different configurations (e.g., types, e.g., speed levels).

In some examples (FIG. 1), the at least one receiving apparatus 130a, . . . is configured to perform signal processing required for receiving data via a corresponding connection 110a, . . . e.g., according to a certain speed level (e.g., according to 100 BASE-T1 or 2.5GBASE-T1 or the like). For example, the signal processing can include: receiving a time signal that characterizes information symbols, decoding the information symbols and forwarding the decoded information symbols, e.g., in the form of a bit stream, e.g., to a next layer, e.g., the coupling network 142 (FIG. 14).

In some examples, a receive signal ES can be pre-processed, for example before it is decoded using the receiving apparatus 130a, since, e.g., in a full-duplex operating mode, a transmit signal and its echoes can superimpose on the receive signal ES, which can cause impairments of the receive signal ES. In some examples these impairments can be eliminated, e.g., before the receive signal is processed by the receiving apparatus 130a. In some examples, the signal processing apparatus 160 can be used to eliminate the aforementioned impairments, as described above.

In some examples, the at least one transmitting apparatus 120a, . . . can be configured to convert information to be transmitted into an electrical signal in the time range according to at least one Ethernet standard, which signal can then be transmitted e.g., via at least one connection 110a, . . . to a connection partner 10, 20 (e.g., a control unit, camera apparatus).

In some examples, at least one transmitting apparatus 120a can implement signal processing for processing information to be transmitted, which can either be provided via a so-called “reconciliation sublayer” (RS) or, if the RS is not implemented, e.g., via a data source that behaves functionally as if RS and, if applicable, MII/GMII/XGMII were implemented, for example in the coupling network 142 (see FIG. 14).

For example, the reconciliation sublayer (RS) is a layer within the ISO/OSI model that ensures that data are transferred compatibly between a media-independent interface (MII) and a physical layer. The abbreviations MII, GMII and XGMII stand for different variants of this interface, which are used depending on the data rate: MII (media-independent interface) for 10/100 Mbit/s Ethernet, GMII (gigabit media-independent interface) for 1 gigabit/s Ethernet, and XGMII (10-gigabit media-independent interface) for 10 gigabit/s Ethernet. These interfaces allow, e.g., a separation of logical and physical network layers and ensure flexible communication between different network components.

Unlike some conventional approaches, in which, e.g., a fixed number of monolithic PHY instances are implemented that are Statically connected to specific pads on a silicon chip, e.g., to form a static (Ethernet) connection, e.g., a port, the principle according to the disclosure allows a dynamic provision and connection of different transmitting apparatuses and/or receiving apparatuses for at least some, for example all, connections 110a, 110b, . . . of the device 100, 100a, 100b. For example, the configuration apparatus 140 can have a configurable switching logic that makes it possible to, at least at times, selectively combine different transmitting apparatuses and/or receiving apparatuses and/or aspects of the signal processing apparatus 160 and/or aspects of local oscillators and/or aspects of mixer apparatuses and/or aspects of filter apparatuses with one another, e.g., to form flexibly configurable connections, e.g., ports, 110a, 110b, . . . , e.g., on different connection pads 101, 102, 103, . . . (FIG. 14) of the device, wherein different combinations can also implement asymmetric ports.

In some examples, using the frequency division multiplexing (FDM) method (see block 350 according to FIG. 9), an efficient separation of uplink and downlink in a frequency range can be provided, wherein e.g., corresponding PHY sub-circuits, e.g., in the form of a transmitting apparatus 120a of the first type and a receiving apparatus 130b of the second type, can be used at least at times with at least one connection 110a, wherein e.g., transmit and receive implementations on the SoC 100, 100a, 100b can also be used efficiently. Furthermore, in some examples, dynamic combinations of different sub-circuits or transmitting and/or receiving apparatuses can be used, e.g., depending on the actual application of the SoC 100, 100a, 100b, e.g., in a target system such as a control unit or vehicle computer, wherein a separation of the signals in the uplink and downlink directions in the frequency range can be implemented, for example using at least one frequency filter, wherein in some examples e.g., the signal processing apparatus 160 can be dispensed with.

In some examples, the principle according to the disclosure can be used for a separation of signals with a comparatively low data transfer rate (see e.g., the spectrum S1 according to FIG. 12) and a comparatively high data transfer rate (see e.g., the spectrum $2 according to FIG. 12) in the frequency range. In some examples, the spectra S1, S2 can also have a non-zero, for example comparatively small, overlap in the frequency dimension (not shown in FIG. 12), wherein the optional signal processing apparatus 160 (FIG. 1) may be used to reduce, e.g., to compensate for, any interference, for example of a receive signal, resulting from the overlap.

In some examples, e.g., a signal to be transmitted, which has e.g., a comparatively low data rate, can be converted, for example shifted, from a baseband to a passband frequency f_{0.2} by using e.g., the “heterodyne” principle on the transmitter side, e.g., because signals with lower bandwidth are easier to handle than signals with higher bandwidth.

In some examples, the passband frequencies for processing transmit signals and/or receive signals can in each case be configured using the frequency division multiplexing method, e.g., according to the selected combined speed levels (e.g., 100 BASE-T1, 2.5GBASE-T1, etc.), and are configurable e.g., for at least one connection 110a, for example all connections 110a, 110b, of the device 100, 100a, 100b, for example using the configuration apparatus 140, for example under the control of the configuration controller 140c.

In some examples (FIG. 1), e.g., currently unused components 120a, . . . 130a, 140, 140a, 140b, 140c, . . . of the device 100, 100a, 100b can be at least temporarily deactivated or put into an energy-saving state, which can save energy.

In some examples (FIG. 14), a time division multiplexing method can be used at least at times for the connection 110b of the device 100a in order to implement an asymmetric connection at the connection 110b, wherein e.g., at times a 100 BASE-T1 transmitting apparatus 120b (see data path al) and at times a 2.5 GBASE-T1 receiving apparatus 130 c (see data path a2) are connected with the connection 110b. The corresponding multiplexers 140a′, 140a″, 140b′, 140b41 are here controlled according to a predefined schedule, e.g., by the configuration controller 140c.

In some examples (FIG. 15), a frequency division multiplexing method can be used at least at times for the connection 110b of the device 100b in order to implement an asymmetric connection at the connection 110b, e.g., with an asymmetric 100 megabit/s downlink and 2.5 gigabit/s uplink connection. To implement the downlink with a comparatively low data rate, e.g., a 100-megabit/s baseband signal of the transmitting apparatus 120b is upconverted to a carrier frequency f_{0.2} using the mixer apparatus 152-2 and the signal from the local oscillator LO2, and is forwarded to the connection 110b; see the data path a3. On the incoming path a4, a low-pass filter apparatus 154 can be used for the 2.5 Gb/s signal, which is present e.g., in the baseband, to separate it e.g., from the transmit signal, e.g., before the incoming 2.5 Gb/s signal is processed by the receiving apparatus 130c.

Further examples (FIG. 17) relate to the use 400 of the device 100, 100a, 100b for coupling network elements according to the disclosure and/or of the method according to the disclosure and/or of the device 200 according to the disclosure and/or of the system 1 according to the disclosure for at least one of the following elements: a) data exchange 401 with at least one further device, or b) exchanging 402 data with different, for example maximum, data rates for transmitting and receiving the data, or c) flexibly configuring 403 at least one connection 110a, . . . of the device 100 for exchanging data with similar or different, for example maximum, data rates for transmitting and receiving the data, or d) increasing 404 the flexibility for a data transfer, or e) implementing 405 data transfers with different, for example maximum, data rates based on, for example conventional, implementations of interface apparatuses.

1-20. (canceled)

21. A device for coupling network elements, comprising:
a plurality of connections configured to connect, at least at times, the device with at least one further device, wherein the device is configured to, at least at times, exchange data with the at least one further device via at least one of the plurality of connections;
at least a first transmitting apparatus of a first type;
at least a second transmitting apparatus of a second type that is different from the first type;
at least a first receiving apparatus of the first type;
at least a second receiving apparatus of the second type;
wherein the device is configured to at least one of: a) selectively transmit data via a first connection of the plurality of connections using the first transmitting apparatus or using the second transmitting apparatus, or b) selectively receive data via the first connection using the first receiving apparatus or using the second receiving apparatus.

22. The device according to claim 21, wherein the first type is associated with a first maximum data transfer rate, wherein, the first maximum data transfer rate includes one of the following elements: a) 100 megabits/s, b) 1000 megabits/s, c) 2500 megabits/s, d) 5000 megabits/s, or e) 10000 megabits/s, and wherein the second type is associated with a second maximum data transfer rate, wherein the second maximum data transfer rate includes one of the following elements: a) 100 megabits/s, b) 1000 megabits/s, c) 2500 megabits/s, d) 5000 megabits/s, or e) 10000 megabits/s.

23. The device according to claim 21, wherein the device is configured to at least at times transmit data via the first connection using the first transmitting apparatus, and to receive data via the first connection using the second receiving apparatus.

24. The device according to claim 23, wherein the transmission and the reception overlap at least partially in time.

25. The device according to claim 21, wherein the device is configured to at least at times transmit data via the first connection using the second transmitting apparatus, and to receive data via the first connection using the first receiving apparatus, wherein the transmission and the reception overlap at least partially in time.

26. The device according to claim 21, wherein the device is configured to at least at times at least one of: a) transmit data via the first connection using the first transmitting apparatus, and receive data via the first connection using the first receiving apparatus, or b) transmit data via the first connection using the second transmitting apparatus, and receive data via the first connection using the second receiving apparatus.

27. The device according to claim 21, further comprising:
a configuration apparatus which is configured for at least one of the following elements: a) connecting the first transmitting apparatus with a specifiable connection of the plurality of connections, b) disconnecting the first transmitting apparatus from a specifiable connection of the plurality of connections, c) connecting the second transmitting apparatus with a specifiable connection of the plurality of connections, or d) disconnecting the second transmitting apparatus from a specifiable connection of the plurality of connections, wherein the connecting and/or the disconnecting can be performed dynamically during operation of the device.

28. The device according to claim 27, wherein the configuration apparatus is configured for at least one of the following elements: a) connecting the first receiving apparatus with a specifiable connection of the plurality of connections, b) disconnecting the first receiving apparatus from a specifiable connection of the plurality of connections, c) connecting the second receiving apparatus with a specifiable connection of the plurality of connections, or d) disconnecting the second receiving apparatus from a specifiable connection of the plurality of connections, wherein the connecting and/or the disconnecting can be performed dynamically during operation of the device.

29. The device according to claim 21, wherein the device is configured to at least at times use a frequency division multiplexing method for the transmission and the reception, at least partially overlapping in time, via at least one of the plurality of connections.

30. The device according to claim 21, wherein the device is configured to at least at times use a time division multiplexing method for the transmission and the reception via at least one of the plurality of connections.

31. The device according to claim 29, wherein the device is configured to transform at least one transmit signal, which is to be transmitted using at least the first transmitting apparatus via at least one of the plurality of connections, into a specifiable frequency range to obtain a bandpass transmit signal, using an upconversion using a signal from a local oscillator of the device, wherein the device includes at least one mixer apparatus for the upconversion, and wherein the device is configured to transmit the bandpass transmit signal via at least one of the plurality of connections.

32. The device according to claim 31, wherein the device is configured to receive a receive signal, at least partially overlapping in time with the transmission of the bandpass transmit signal, via the same connection via which the bandpass transmit signal is transmitted, wherein the receive signal occupies, at least predominantly, a different frequency range than the bandpass transmit signal.

33. The device according to claim 32, wherein the bandpass transmit signal has a smaller bandwidth than the receive signal, wherein the bandpass transmit signal is associated with a maximum data rate of 100 megabits/s or less, and wherein the receive signal is associated with a data rate greater than 100 megabits/s.

34. The device according to claim 29, wherein the device has at least one filter apparatus for low-pass filtering of a receive signal.

35. The device according to claim 21, wherein the device is configured monolithically as a system on a chip (SoC), wherein all components of the device are arranged on a common substrate.

36. The device according to claim 21, further comprising at least one signal processing apparatus configured to process a receive signal received via at least one connection of the plurality of connections based on a transmit signal transmitted via the connection, at least partially overlapping in time with the receive signal, to at least partially compensate for a possible influence of the transmit signal on the receive signal.

37. A method for a device for coupling network elements, wherein the device includes a plurality of connections for at least at times connecting the device with at least one further device, wherein the device is configured to at least at times exchange data with the at least one further device via at least one of the plurality of connections, wherein the device further includes: at least a first transmitting apparatus of a first type, at least a second transmitting apparatus of a second type that is different from the first type, at least a first receiving apparatus of the first type, at least a second receiving apparatus of the second type, wherein the method comprises at least one of the following:
a) selectively transmitting data via a first connection of the plurality of connections using the first transmitting apparatus or the second transmitting apparatus, or
b) selectively receiving data via the first connection using the first receiving apparatus or the second receiving apparatus.

38. A device for data exchange with a device for coupling network elements, the device for coupling network elements including:
a plurality of connections configured to connect, at least at times, the device for coupling network elements with at least one further device, wherein the device for coupling network elements is configured to, at least at times, exchange data with the at least one further device via at least one of the plurality of connections,
at least a first transmitting apparatus of a first type,
at least a second transmitting apparatus of a second type that is different from the first type,
at least a first receiving apparatus of the first type,
at least a second receiving apparatus of the second type,
wherein the device for coupling network elements is configured to at least one of: a) selectively transmit data via a first connection of the plurality of connections using the first transmitting apparatus or using the second transmitting apparatus, or b) selectively receive data via the first connection using the first receiving apparatus or using the second receiving apparatus;
wherein the device for data exchange comprises:
at least one connection for at least at times connecting the device for data exchange with the device for coupling network elements;
a transmitting apparatus of a third type; and
a receiving apparatus of a fourth type, wherein the fourth type is different from the third type.

39. A system, comprising:
a device for coupling network elements, including:
a plurality of connections configured to connect, at least at times, the device for coupling network elements with at least one further device, wherein the device for coupling network elements is configured to, at least at times, exchange data with the at least one further device via at least one of the plurality of connections,
at least a first transmitting apparatus of a first type,
at least a second transmitting apparatus of a second type that is different from the first type,
at least a first receiving apparatus of the first type,
at least a second receiving apparatus of the second type,
wherein the device for coupling network elements is configured to at least one of: a) selectively transmit data via a first connection of the plurality of connections using the first transmitting apparatus or using the second transmitting apparatus, or b) selectively receive data via the first connection using the first receiving apparatus or using the second receiving apparatus; and
a device for data exchange with the device for coupling network elements, the device for data exchange including:
at least one connection for at least at times connecting the device for data exchange with the device for coupling network elements;
a transmitting apparatus of a third type; and
a receiving apparatus of a fourth type, wherein the fourth type is different from the third type.

40. The device according to claim 21, wherein the device is configured for at least one of the following elements: a) data exchange with the at least one further device, b) exchanging data with different, maximum data rates for transmitting and receiving the data, c) flexibly configuring at least one connection of the device for exchanging data with similar or different maximum data rates for transmitting and receiving the data, d) increasing flexibility for a data transfer, or e) implementing data transfers with different maximum data rates based on conventional implementations of interface apparatuses.
